(19) United States
(12) Patent Application Publication
(10) Pub. No.: US 2018/0203977 A1
(43) Pub. Date: Jul. 19, 2018

(54) SYSTEMS AND METHODS FOR REAL-TIME VERIFICATION FOR CONTROLLED SUBSTANCES

(71) Applicant: Kevin Laxer, Los Angeles, CA (US)

(72) Inventor: Kevin Laxer, Los Angeles, CA (US)

(21) Appl. No.: 15/406,538

(22) Filed: Jan. 13, 2017

(51) Int. Cl. G06F 19/00; G06F 17/30

(52) U.S. Cl. CPC G06F 19/326; G06F 19/3406; G06F 17/30309; G06F 17/30867; G06F 19/322

(57) ABSTRACT

The invention refers to a system for real-time verification of controlled substances. A server is communicatively coupled to one or more controlled substance databases. The server's local database maintains data obtained from searches of the controlled substance databases. A user connects with a smart device and provides their login credentials for one of the controlled substance databases to the server which validates the user's credentials with the controlled substance database. The user acquires identification information from a subject with the smart device, which sends the identification information to the server. The server searches the controlled substance database and the local database to obtain the subject's prescription history to send to the smart device for display to said user. The user enters a prescription intent for the subject into the smart device, which sends it to the server. The prescription history and intent are saved in the local database in real-time.

### BACKGROUND OF THE INVENTION

### Field of the Invention

Embodiments of the invention relates to systems and methods for verification of the history of intents for controlled substances in real-time to prevent diversion and abuse.

### Description of the Related Art

There are currently no known systems that provide verification of controlled substances in such a way to prevent diversion and abuse. Current systems for management of controlled substances, e.g. prescription drugs, are administered in each separate state or jurisdiction. For instance, each state in the United States administers a Prescription Drug Management Program (“PDMP”). In California, for example, the PDMP database is referred to as the Controlled Substance Utilization Review and Evaluation System (“CURES”) database. Subscribers to these PDMP databases are generally doctors and pharmacists.

Subscribers to these systems generally do not enter information about prescriptions into the systems in real-time. In cases where the subscribers enter the information into the jurisdictional database in real-time, nothing prevents an abusive subject from crossing jurisdictions to get new prescriptions. This is particularly problematic in places, e.g. cities, that border two or more states. In such cases, a potential abuser can simply walk across states lines to see different doctors and get prescriptions for the same medication within the same day without being flagged by current systems.

This is particularly problematic because some local doctors dispense controlled substances in their offices thus bypassing the pharmacist. Without the ability to verify prescriptions, filled or unfilled, in real-time, abuse cannot be completely curbed.

To overcome the problems and limitations described above there is a need for a system that meets all the regulatory requirements and provides, in real-time, the history of a controlled substance prescribed to or filled for a particular subject.

### BRIEF SUMMARY OF THE INVENTION

One or more embodiments of the invention are directed a systems and methods for real-time verification of controlled substances. The system comprises one or more controlled substance database such as the Prescription Drug Management Programs CURES database maintained by each state.

In one or more embodiments, a server is communicatively coupled to the one or more controlled substance databases through a communications network such as the Internet, for example. A user connects to the server with a smart device. The smart device obtains and sends the user's login credentials for one of the controlled substance databases to the server. The user's login credentials comprise the Username and Password for one of the controlled substance databases.

In one or more embodiments, the smart device is a smartphone, tablet computer, a laptop computer, desktop computer, or similar type devices. The smart device sends the user's credentials to the server which validates the credentials with the controlled substance database. This assures that the user is one with access rights to the controlled substance database. Those of skill in the art would appreciate that the controlled substance could be drugs or any other substance or device that is strictly controlled by a by a management body, e.g. a government entity.

In one or more embodiments, the user acquires a subject's identification information with smart device. The subject's identification may be obtained in various ways. For example, the smart device could launch a graphical user interface with which to acquire an image of the subject's driver's license using a built-in or coupled camera. Also, the smart device could launch a graphical user interface for scanning a barcode on the subject's prescription or graphical user interface with text fields for manually entering the subject's identification information. The driver's license image and the Rx barcode should have information to identify the subject. The identification information of the subject comprises one or more of first name, last name, date of birth, social security number, driver's license number, and domicile.

Once the subject is identified, the server searches the controlled substance database and its local database for the subject's prescription history, i.e. filled and unfilled prescriptions. Ideally, the controlled substance database contains the filled prescriptions for the subject and the local database contains the unfilled prescriptions. However, one or more users, e.g. doctors, who locally dispense controlled substances may not have had time to enter the information into the controlled substance database thus the information from the local database serves as a check.

In one or more embodiments, the local database is a secured cloud database controlled by said server. The server obtains and sends subject's prescription history to the smart device for display to the user. By displaying the prescription to the user, the user is fully aware of all previous prescriptions of the same or similar controlled substance for the subject. Since the prescription history is based on an immediate database search, the user has in real-time all known information about the prescription of the user.

If after seeing the prescription history of the subject, the user still wants to proceed with issuing a prescription to the subject, the smart device presents an interface to the user requesting the prescription intent. The user may then enter the prescription intent for the subject into the smart device which sends it to the server.

In one or more embodiments, the server securely saves the subject's prescription history and the prescription intent in the local database. By immediately saving the prescription history and the prescription intent in the local database, the data is instantly available to any other user of any of the controlled substance databases wishing to issue a prescription for the same subject. Thus, even if the subject crosses jurisdictions, e.g. state lines, to try and get additional prescriptions for the same or similar controlled substance, the information of all previous transactions is immediately available and provided to the user.

### BRIEF DESCRIPTION OF THE DRAWINGS

The above and other aspects, features and advantages of the invention will be more apparent from the following more particular description thereof, presented in conjunction with the following drawings wherein:

FIG. 1 is a flowchart illustrating the process of verifying and dispensing of controlled substances in accordance with one or more embodiments of the present invention.

FIG. 2 is a flowchart illustrating the process of acquiring a subject's information in accordance with one or more embodiments of the present invention.

FIG. 3 is an exemplary login graphical user interface for the systems in accordance with one or more embodiments of the present invention.

FIG. 4 is an exemplary graphical user interface for selection of identification method of the subject in accordance with one or more embodiments of the present invention.

FIG. 5A is an exemplary graphical user interface for using a subject's driver's license for identification in accordance with one or more embodiments of the present invention.

FIG. 5B is an exemplary graphical user interface for using the barcode on a subject's prescription for identification in accordance with one or more embodiments of the present invention.

FIG. 5C is an exemplary graphical user interface for using text fields to enter a subject's identification in accordance with one or more embodiments of the present invention.

FIG. 6 is an exemplary progress display graphical user interface in accordance with one or more embodiments of the present invention.

FIGS. 7A-B are exemplary graphical user interfaces for obtaining intents for a controlled substance in accordance with one or more embodiments of the present invention.

FIGS. 8A-B are exemplary graphical user interfaces showing prior controlled substance intents of the subject in accordance with one or more embodiments of the present invention.

FIG. 9A is an exemplary graphical user interface showing history of past searches in accordance with one or more embodiments of the present invention.

FIG. 9B is an exemplary graphical user interface for user settings in accordance with one or more embodiments of the present invention.

FIG. 10 illustrates a general-purpose computer and peripherals that when programmed as described herein may operate as a specially programmed computer capable of implementing one or more methods, apparatus and/or systems of the present invention.

FIG. 11 is a flowchart illustrating the process of verifying dispensing of controlled substances performed by the system server in accordance with one or more embodiments of the present invention.

FIG. 12 is a flowchart illustrating the process of verifying dispensing of controlled substances performed by a user's smart device in accordance with one or more embodiments of the present invention.

### DETAILED DESCRIPTION

The present invention comprising systems and methods for real-time verification of controlled substances will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

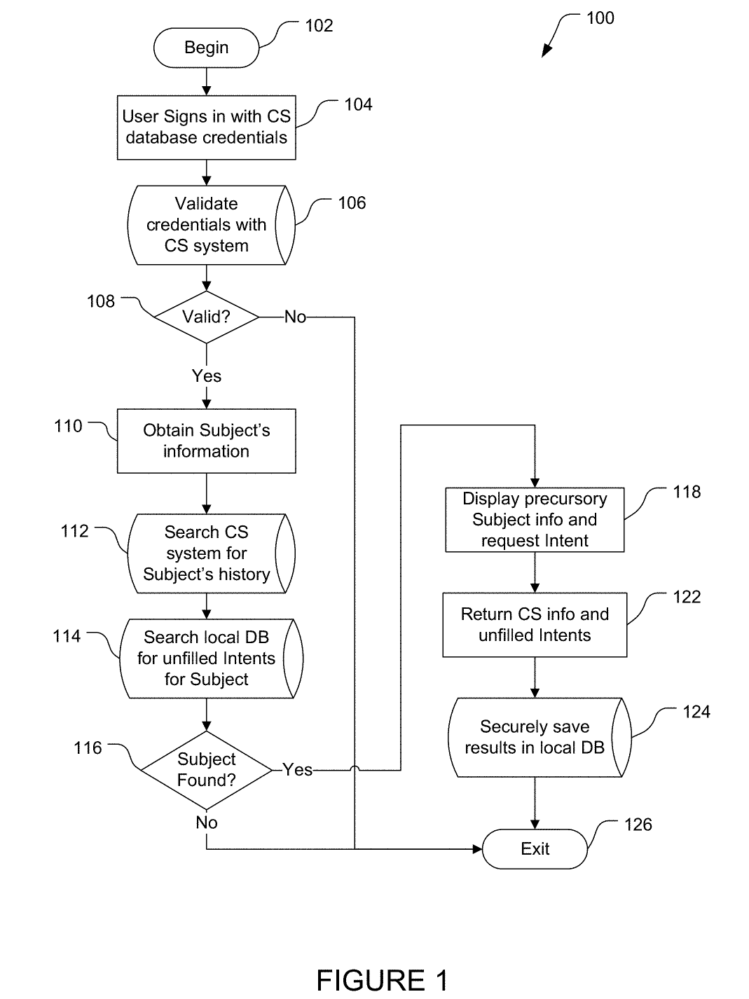

One or more embodiments of the present invention will now be described with references to FIGS. 1-12.

FIG. 1 is an illustration of process 100 for verification and dispensing of controlled substances in accordance with one or more embodiments of the present invention. As illustrated, the process begins at step 102 by a user launching a software application (“App”) for the system of the present invention on a smart device, e.g. a smartphone, tablet, laptop, etc. A smart device with wireless, e.g., cellular or Wi-Fi, capability is preferable because the prescriber/user may connect to the required databases in real-time to have up to date history of the subject in relation to controlled substances.

In step 104, the App launches a user interface for the user to log into the system with their controlled substance (“CS”) database credentials, e.g. identification and password, fingerprint, facial recognition, etc. As would be evident from these descriptions, the systems of the present invention may be used for various types of controlled products. In the case of prescription drugs, the user may be a physician or pharmacist, for example. For other controlled products, e.g. guns, the user may be a salesman at a gun show or a proprietor of a gun shop, etc.

In the following descriptions, management of prescription drugs would be used for exemplary purposes only. Those of skill in the art would appreciate that the systems and methods described herein would be applicable to other types of controlled products/substances thus are not limited to embodiments described herein.

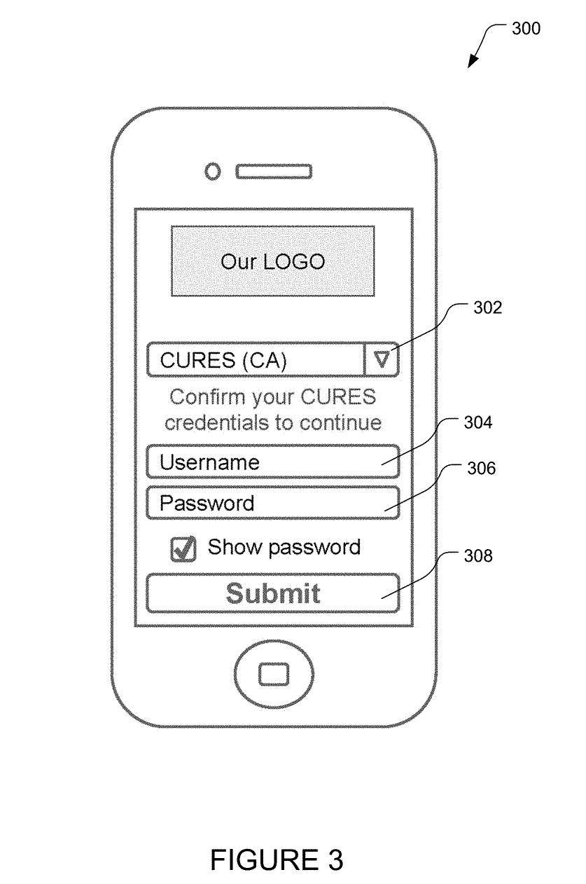

FIG. 3 is an exemplary login graphical user interface 300 for a user to log into the system in accordance with one or more embodiments of the present invention. As illustrated, the user selects which controlled substance database to log into using the dropdown menu block 302. In the illustrated example, the user selects the California Prescription Drug Management Program (“PDMP”) CURES (“Controlled Substance Utilization Review and Evaluation System”) database. The user enters his/her credentials comprising the PDMP Username in field 304 and PDMP Password in field 306 and then selects the “Submit” button 308.

Returning back to FIG. 1, in step 106, the system validates the user's login information, i.e. credentials, with the selected controlled substance database 302, e.g. California PDMP-CURES database, after selection of the Submit button 308. In step 108, if a determination is made that the user is not a valid and registered user of the selected database, the system may exit at step 126 or return to step 104 for the user to reenter the correct login information.

However, if at step 108 a determination is made that the user is a valid user of the selected database, the system proceeds to step 110 to obtain a subject's information. In the case of a prescription drug, the subject may be a patient, for example.

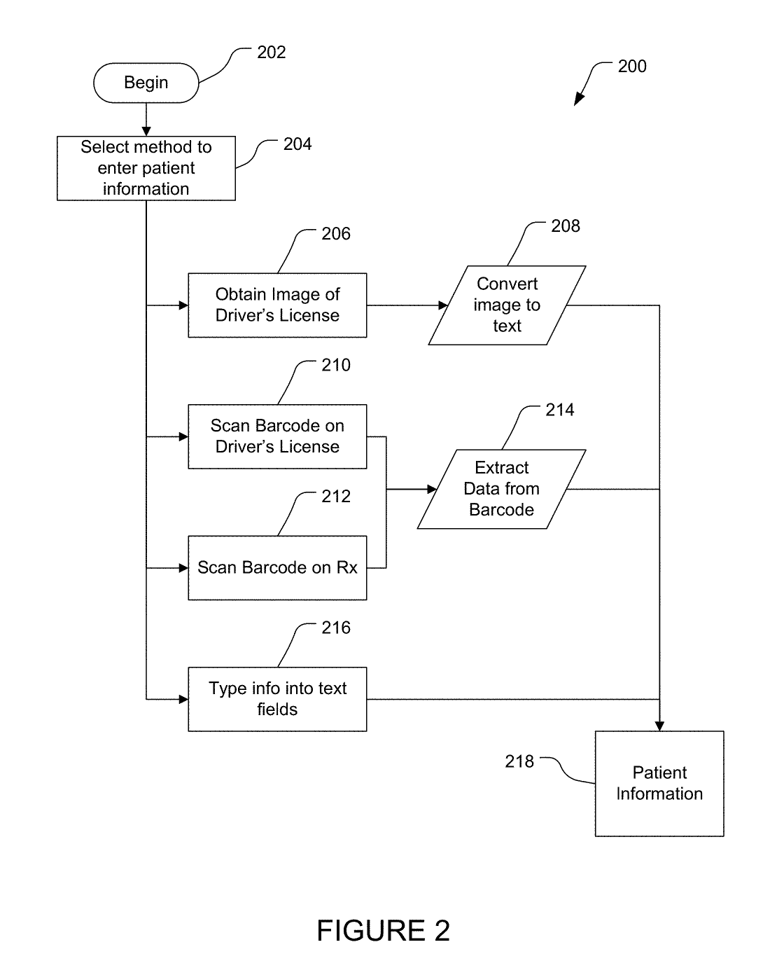

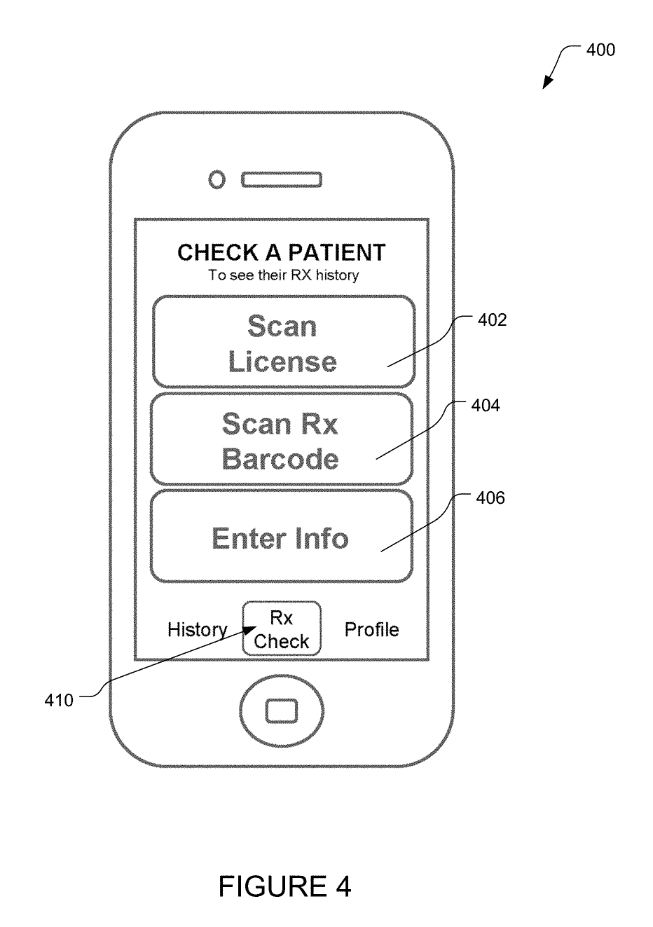

FIG. 2 is a flowchart illustrating the process 200 of acquiring a subject's information in accordance with one or more embodiments of the present invention. As illustrated, the process begins at step 202, and at step 204 the user is prompted to select a method to enter the subject's identification. FIG. 4 is an exemplary graphical user interface (GUI) 400 for the user to select an identification method for the subject in accordance with one or more embodiments of the present invention. In this illustrated example, the user first selects “Rx Check” menu 410 for prescriptions. The user may then select button 402 to scan the subject's Driver's License, button 404 to scan a prescription (Rx) barcode, or button 406 to manually enter the required information.

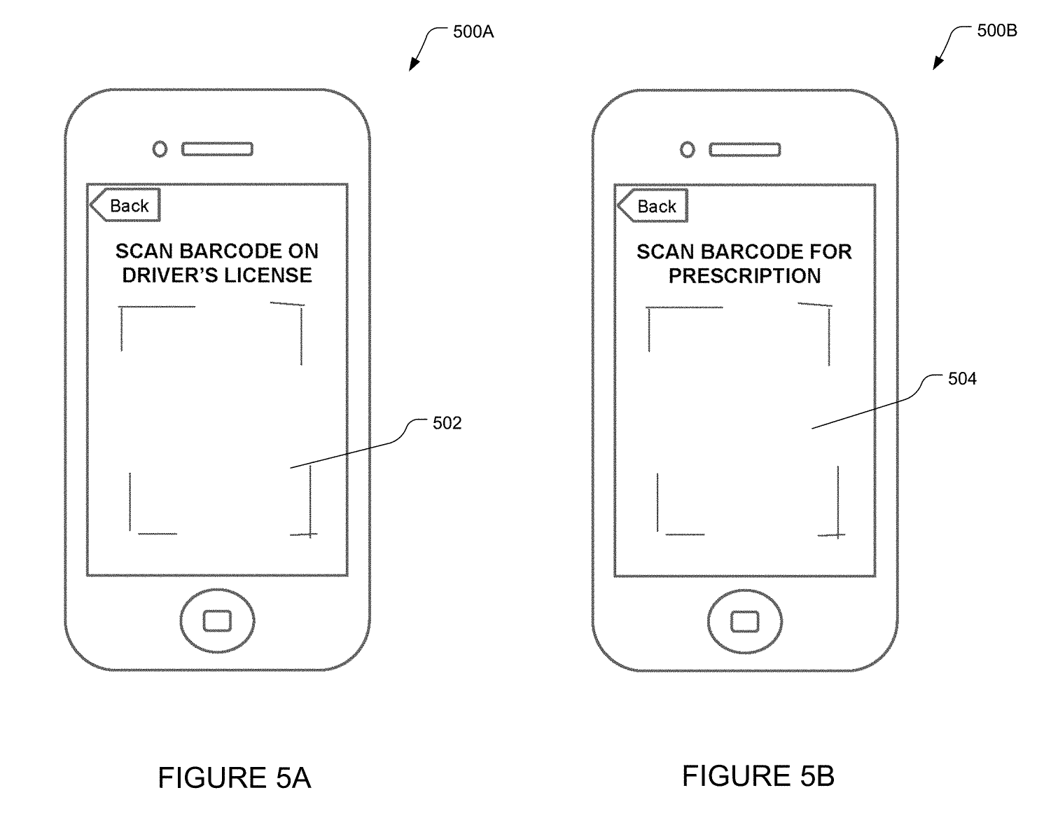

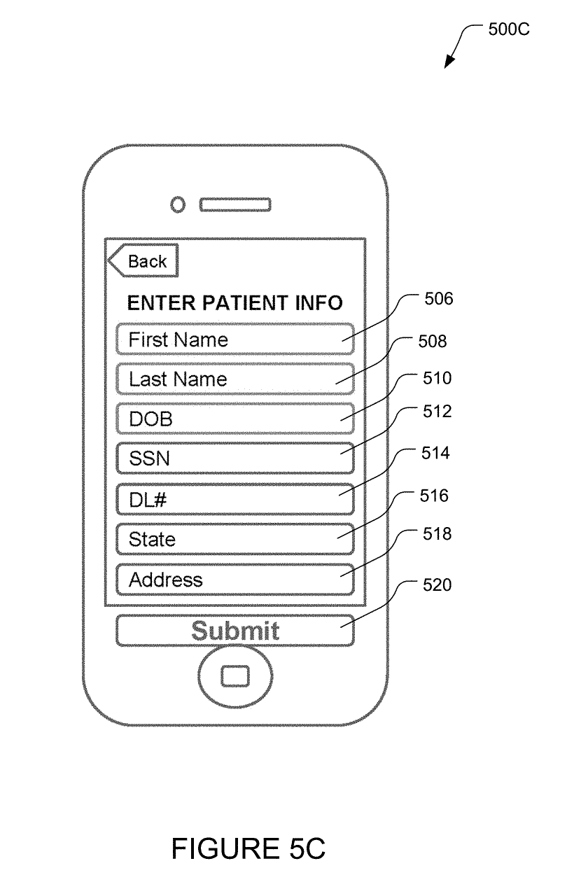

If the user selects button 402, for example, the subject's identification information may be acquired from his/her state's driver's license, e.g. by image recognition in block 206 and converting the image to text in block 208. Image recognition is performed by capturing an image of the subject's driver's license using, for example, the graphical user interface 500A, illustrated in FIG. 5A. The subject's image may be captured using a camera on a smartphone, for example. An alternate method of acquiring the subject's identification information may by reading the barcode on the subject's driver's license image 500A in block 210. The subject's identification data 218 is subsequently extracted from the barcode in block 214.

Returning back to FIG. 4, if the user selects button 404, for example, the subject's identification information may be acquired from his/her prescription in block 212. An image of the subject's prescription may be captured, for example, using the graphical user interface 500B, illustrated in FIG. 5B. The subject's identification data 218 is subsequently extracted from the barcode in block 214.

If in GUI 400 the user selects button 404, for example, the subject's identification information may be acquired by the user manually entering the required information into text fields in step 216. FIG. 5C is an exemplary graphical user interface 500C for using text fields to enter a subject's identification in accordance with one or more embodiments of the present invention. As illustrated, the user may enter information into fields 506 for first name, 508 for last name, 510 for date of birth, 512 for social security number, 514 for driver's license number, and the subject's domicile, e.g. 516 for the subject's state of resident, and 520 for the subject's address. After entering at least one of the data 506-518 as the subject identification data 218, the user selects the Submit button 520.

After the subject's identification information 218 is acquired, using any of the above methods, or any other available method, the system proceeds to steps 112 and 114 (FIG. 1) to search the selected database 302 and the system's local database for the subject. Those of skill in the art would appreciate that the system's local database is a secured database that is preferably governed by and meets all regulatory requirements of the selected database 302. For instance, the CURES database is governed by the Health Insurance Portability and Accountability Act of 1996 (HIPAA) and confidentiality and disclosure provisions of the various jurisdictions, i.e. states.

In one or more embodiments, the selected database contains history of filled prescriptions and the local database contains history of prescription intents, e.g. unfilled prescriptions. Thus, the search in the local database in step 114 returns history of unfilled prescriptions for the subject, which is up-to-date.

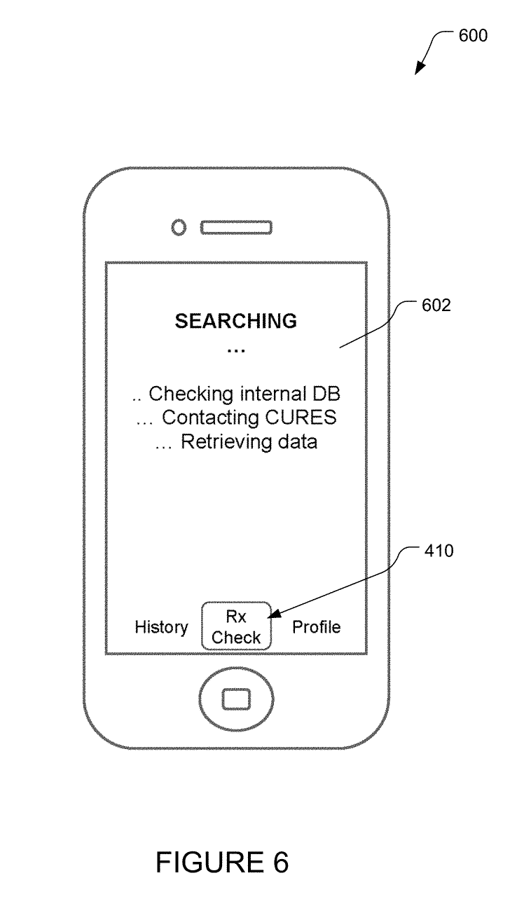

In step 116, if a determination is made that the subject is not in the selected database, the system may exit at step 126 or return to step 110 for the user to reenter the correct subject information. The subject may also be new to the system, in which case, the user would need to add the subject to the database using the appropriate method. FIG. 6 is an exemplary progress display graphical user interface 600 in accordance with one or more embodiments of the present invention. Window 602 shows the progress of the search being conducted on the subject on the various databases.

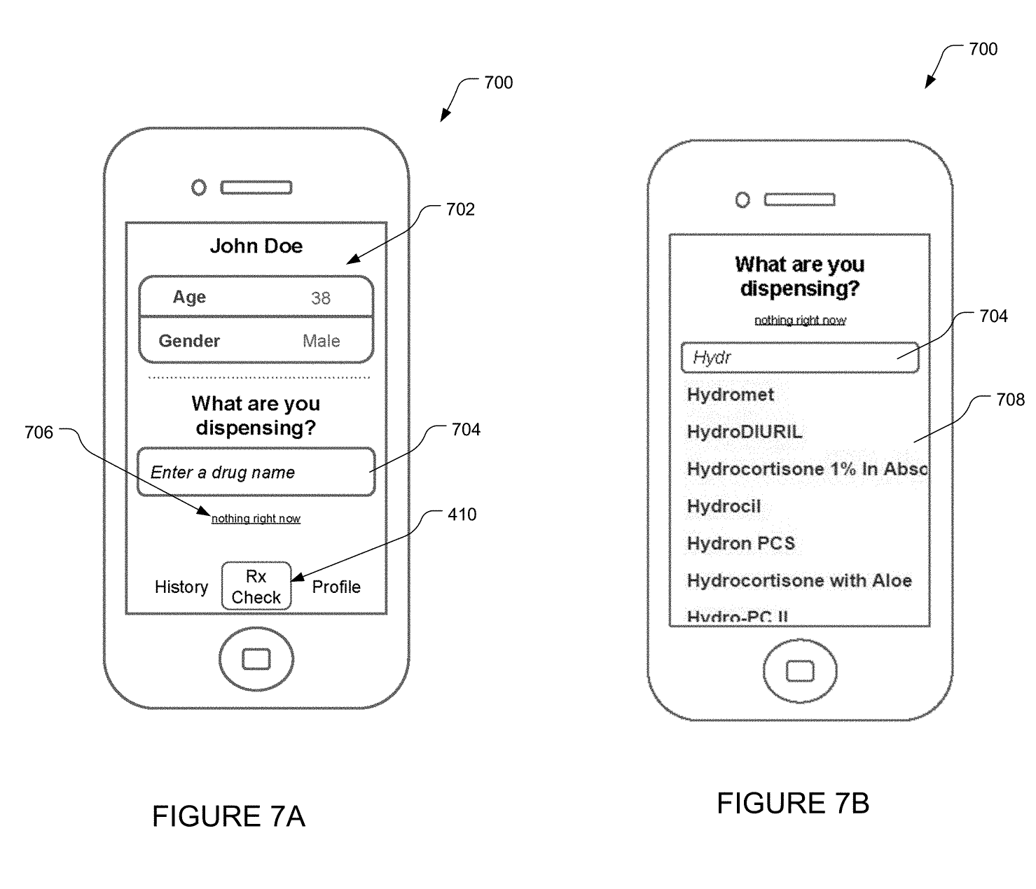

Returning back to FIG. 1, if at step 116 a determination is made that the subject is in the selected database and/or local database, the system proceeds to step 118 to display precursory subject's information to the user and to request prescriptions intents. FIG. 7A is an exemplary graphical user interface 700 illustrating subject information 702 and field 704 for entering the intents for a controlled substance from the user in accordance with one or more embodiments of the present invention. As illustrated, field 704 is provided for the user to enter the name of the prescription desired, or if no prescription, then selection 706 to exit.

As the user types ahead into field 704, a drop down list of options 708 may be provided as illustrated in FIG. 7B to simplify the data entry process. If the user desires a prescription from the list, the user may select the desired prescription from the list 708 without having to fully type in the name in the text field.

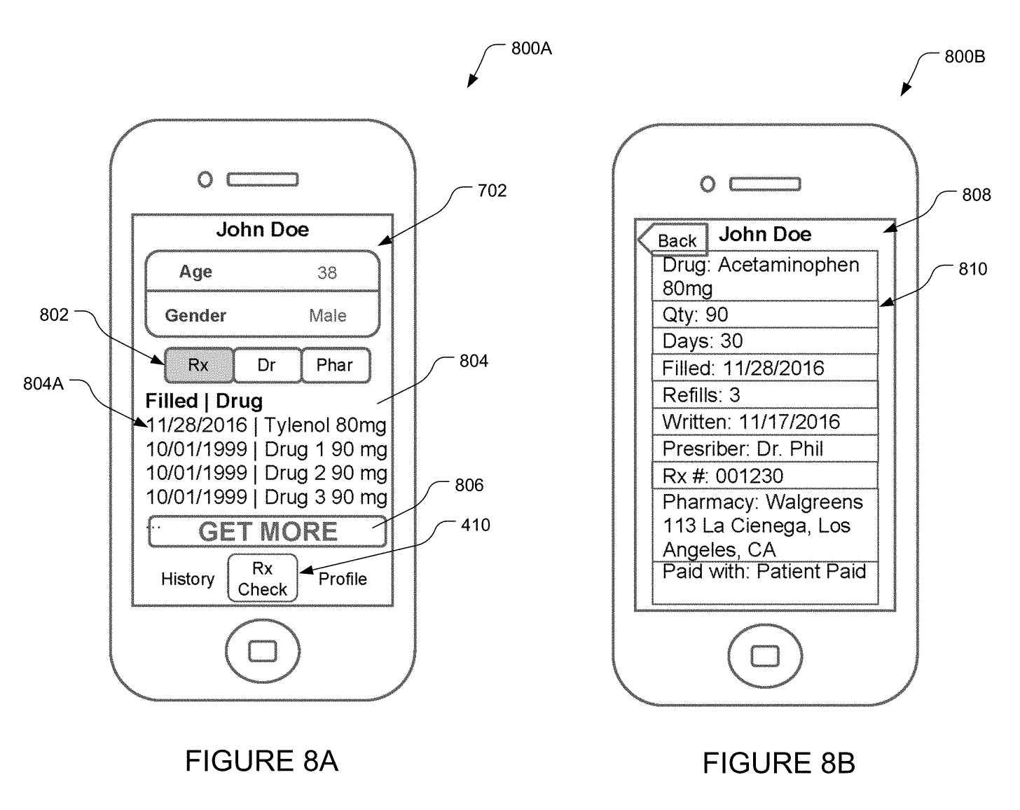

Returning back to FIG. 1, once the desired prescription is entered, the system proceeds to step 122 to display, if any, one or more of the prior intents of controlled substances for the subject, e.g. prescription history, from the result of the searches in the various databases, as illustrated in FIG. 8A.

FIG. 8A is an exemplary graphical user interface 800A showing prescription history for the subject in accordance with one or more embodiments of the present invention. As illustrated, the subject's identification information is displayed in field 702. Field 802 provides for selection of the type of information the user desires to be displayed in window 804. For instance, the user may review prior prescriptions by selecting “Rx”; the doctors that provided the prior prescriptions by selecting “Dr”; or the pharmacy that filled the prescription by selecting “Phar”. The “GET MORE” button provides for scrolling to additional hidden information that did not fit in window 804.

In one or more embodiments, the user may review any of the listed items in window 804 by selecting it, e.g. 804A. Upon selection, details of the selected prescription intent are presented as exemplified in FIG. 8B, which is an exemplary graphical user interface 800B showing details of a selected prior controlled substance intent of the subject in accordance with one or more embodiments of the present invention. As illustrated, GUI 800B includes field 808 for the subject's identification; and window 810 for the details of the prescription intent. Window 810 may include one or more of the following fields: the name of the “Drug”; the quantity (“Qty”); the number of days for the prescription; the date the intent was “Filled”; the number of “Refills” available; the prescribing doctor (“Prescriber”); the prescription number (“Rx #”); the pharmacy that filled the prescription; and how it was paid for.

Returning back to FIG. 1, in step 124, the system saves the results of the database searches from steps 112 and 114 and any new prescription intents for the subject in the local database. Thus, by saving the results in the local database, in time the local database will be fully populated with prescription intents from all the various jurisdictions wherein there is a user of the systems and methods of the present invention.

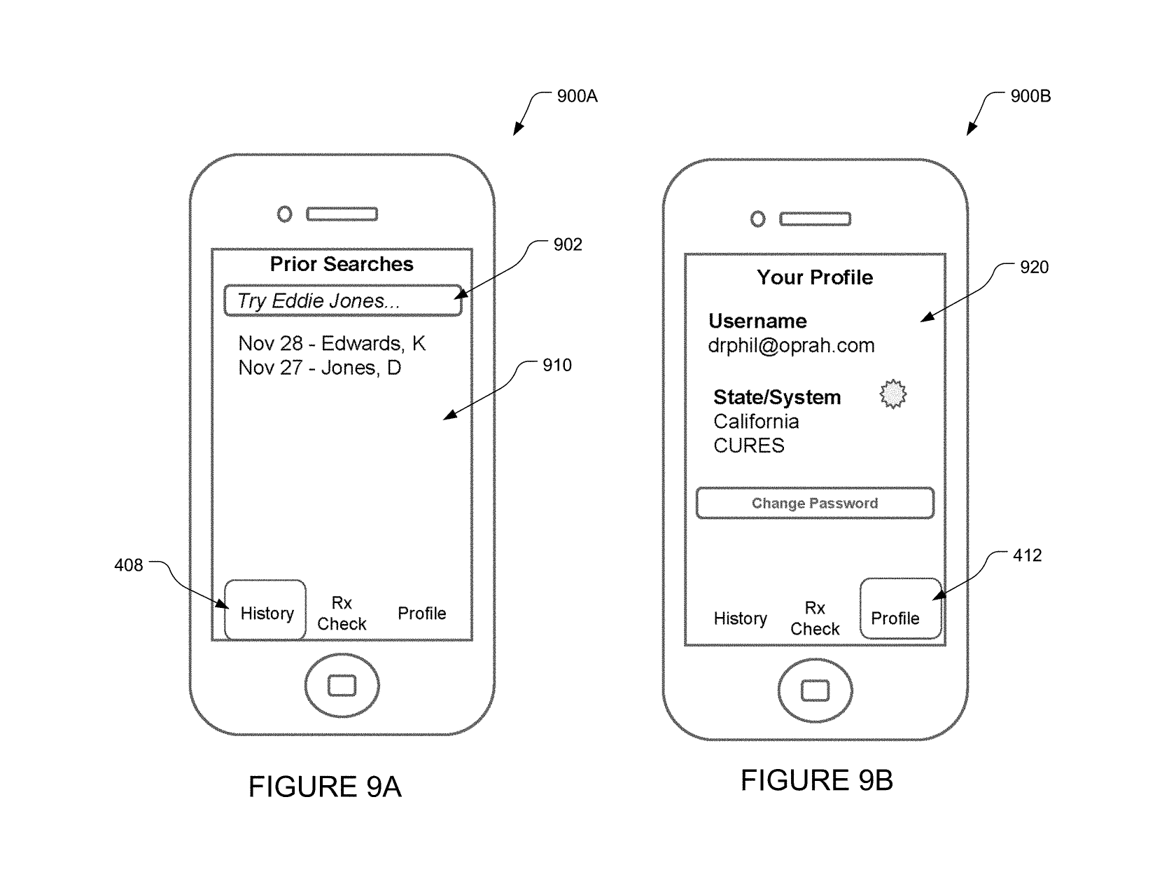

In one or more embodiments, the system provides for the user to review prior searches for one or more subjects by selecting the “History” button 408. FIG. 9A is an exemplary graphical user interface 900A showing history of past searches in accordance with one or more embodiments of the present invention. As illustrated, GUI 900A includes a text field 902 for the user to enter the search terms, e.g. name of a subject; and window 910 displays the result of the search.

In one or more embodiments, the system provides for the user to review and update his/her profile by selecting the “Profile” button 412. FIG. 9B is an exemplary graphical user interface 900B for user settings in accordance with one or more embodiments of the present invention. As illustrated, GUI 900B includes window 920 showing the user settings, e.g. “Username”; the jurisdiction (e.g. state) for which he/she is registered. The system may also provide for the user to be able to change any of the profile information or user settings, e.g. password, etc.

In one or more embodiments, the system periodically reconciles the local database with the one or more controlled substance databases. The reconciliation process minimizes duplication of data between the controlled substance databases and the local database. Also, reconciliation serves the function of updating prescription intents in the local database that ultimately became filled prescriptions.

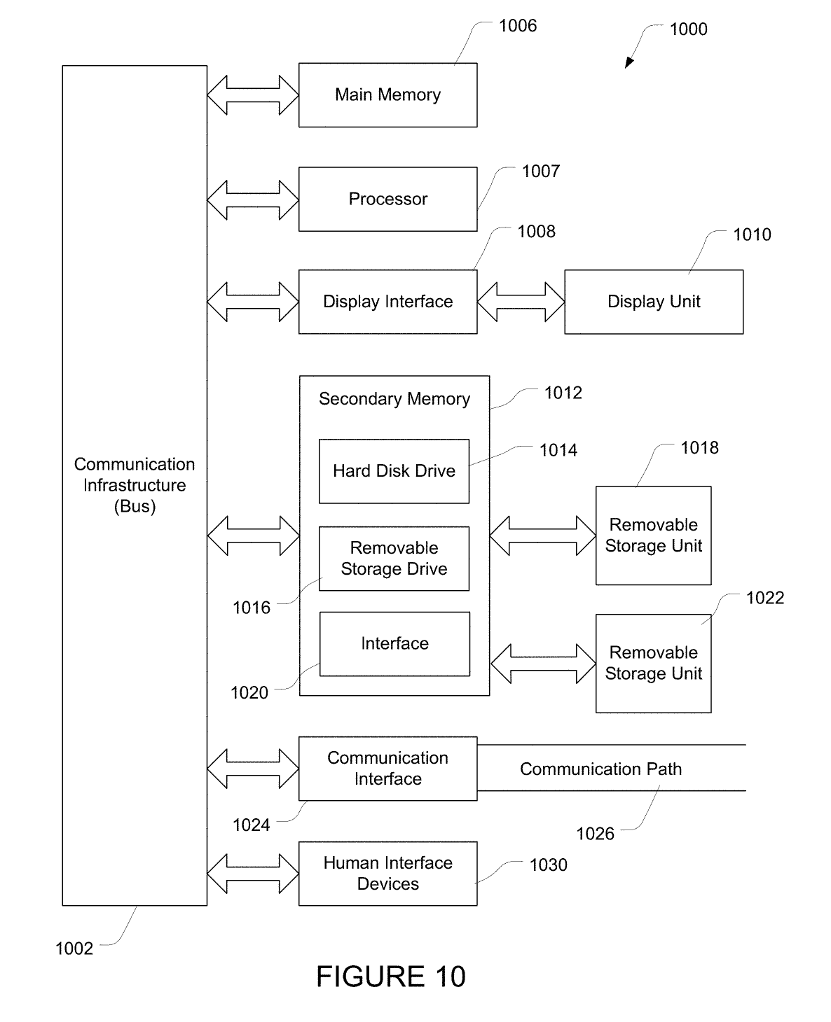

FIG. 10 diagrams a general-purpose computer and peripherals 1000, when programmed as described herein, may operate as a specially programmed computer capable of implementing one or more methods, apparatus and/or systems of the solution described in this disclosure. Processor 1007 may be coupled to bi-directional communication infrastructure 1002 such as communication infrastructure system bus 1002. Communication infrastructure 1002 may generally be a system bus that provides an interface to the other components in the general-purpose computer system such as processor 1007, main memory 1006, display interface 1008, secondary memory 1012 and/or communication interface 1024.

Main memory 1006 may provide a computer readable medium for accessing and executed stored data and applications. Display interface 1008 may communicate with display unit 1010 that may be utilized to display outputs to the user of the specially- programmed computer system. Display unit 1010 may comprise one or more monitors that may visually depict aspects of the computer program to the user. Main memory 1006 and display interface 1008 may be coupled to communication infrastructure 1002, which may serve as the interface point to secondary memory 1012 and communication interface 1024. Secondary memory 1012 may provide additional memory resources beyond main memory 1006, and may generally function as a storage location for computer programs to be executed by processor 1007. Either fixed or removable computer-readable media may serve as Secondary memory 1012. Secondary memory 1012 may comprise, for example, hard disk 1014 and removable storage drive 1016 that may have an associated removable storage unit 1018. There may be multiple sources of secondary memory 1012 and systems implementing the solutions described in this disclosure may be configured as needed to support the data storage requirements of the user and the methods described herein. Secondary memory 1012 may also comprise interface 1020 that serves as an interface point to additional storage such as removable storage unit 1022. Numerous types of data storage devices may serve as repositories for data utilized by the specially programmed computer system. For example, magnetic, optical or magnetic-optical storage systems, or any other available mass storage technology that provides a repository for digital information may be used.

Communication interface 1024 may be coupled to communication infrastructure 1002 and may serve as a conduit for data destined for or received from communication path 1026. A network interface card (NIC) is an example of the type of device that once coupled to communication infrastructure 1002 may provide a mechanism for transporting data to communication path 1026. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 1026 may comprise any type of telecommunication network or interconnection fabric that can transport data to and from communication interface 1024.

To facilitate user interaction with the specially programmed computer system, one or more human interface devices (HID) 1030 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 1007 to trigger one or more responses from the specially programmed computer are within the scope of the system disclosed herein.

While FIG. 10 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. In one or more embodiments, the system may also encompass parallel systems, multi-processor systems, multi-core processors, and/or any combination thereof. Where a virtual machine, process, device or otherwise performs substantially similarly to that of a physical computer system, such a virtual platform will also fall within the scope of disclosure provided herein, notwithstanding the description herein of a physical system such as that in FIG. 10.

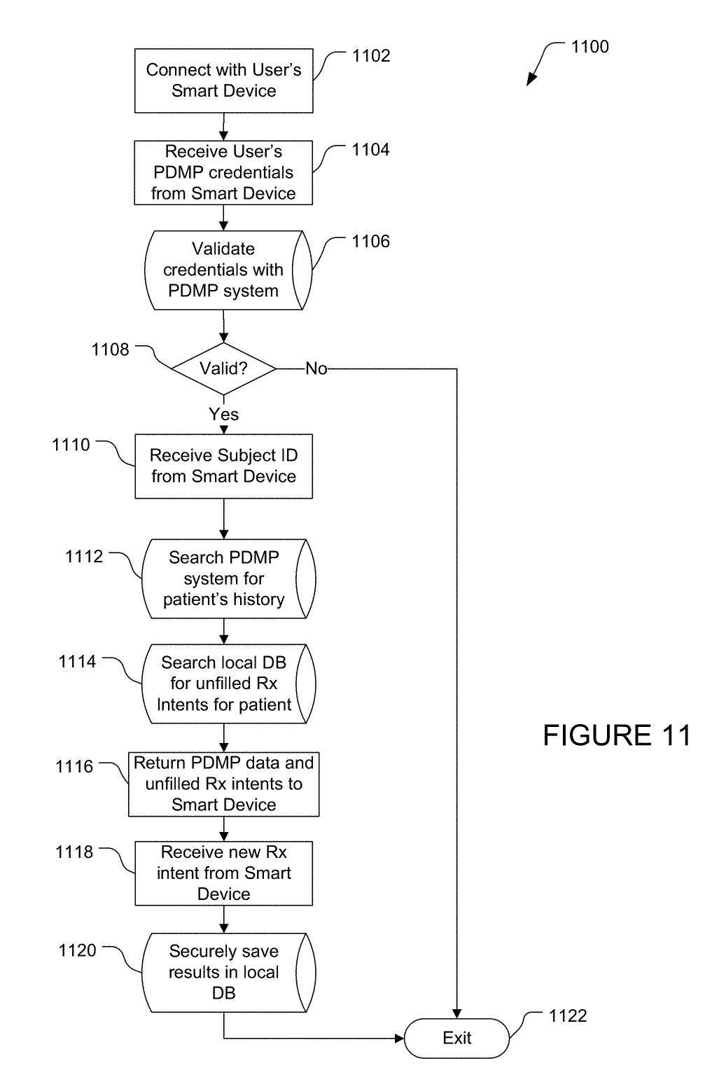

FIG. 11 is a flowchart illustrating the process 1100 for verifying dispensing of controlled substances performed by the system server in accordance with one or more embodiments of the present invention.

The system of the present invention may comprise one or more computer servers, e.g. general-purpose computer 1000, and applicable data storage devices for maintaining the system's local database. In one or more embodiments, the local database may be maintained in a cloud or other storage systems with ease of access over a communications network, e.g. the Internet, and limitless capacity. The server connects with a user's smart device at step 1102 and receives login credentials of the user for a controlled substance database in step 1104. The server then validates the user's credentials with the controlled substance database in step 1106. If at step 1108, the server confirms the user with the controlled substance database, the server sends acknowledgment to the smart device that the user is valid and at step 1110 receives identification information for a subject that the user wants information on regarding previous filled and unfilled prescription intents.

In one or more embodiments, the server receives the identification information of the subject in step 1110 and uses information to search the controlled substance database for filled prescriptions, step 1112, and the local database for unfilled prescriptions, step 1114, for the subject based on the identification information. In step 1116, the server obtains and returns the subject's prescription history to the smart device for presentation to the user. The prescription history comprises filled and unfilled prescriptions for the subject.

In one or more embodiments, the server requests and receives a prescription intent for the subject from the smart device, step 1118, and securely saves the subject's prescription history and the new prescription intent in the local database, step 1120. Process 1100 ends in step 1122.

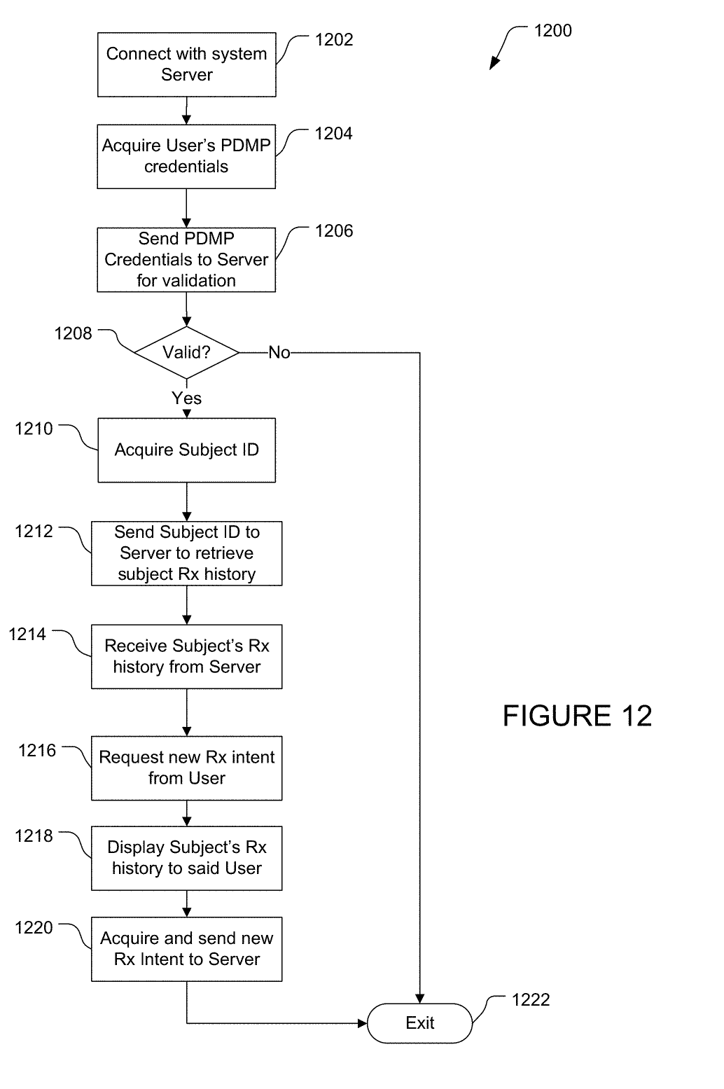

FIG. 12 is a flowchart illustrating the process 1200 for verifying dispensing of controlled substances performed by a user's smart device in accordance with one or more embodiments of the present invention.

In one or more embodiments, the smart connects with the system server at step 1202, and obtains login credentials of the user for a controlled substance database at step 1204. For example, the smart device may present the user with dropdown menu for selecting one from a list of controlled substance databases. The user enters the required information, which comprises the user's login credentials for a selected controlled substance database. The smart device sends the login credentials of the user to the server for validation of the user with the selected controlled substance database, step 1206.

Upon receiving confirmation from the server that the user is valid, step 1208, the smart device acquires a subject's identification information from the user, step 1210. The subject's identification information may be obtained in various ways. For example, the smart device could launch a graphical user interface with which to acquire an image of the subject's driver's license using a built-in or coupled camera. Also, the smart device could launch a graphical user interface for scanning a barcode on the subject's prescription or a graphical user interface with text fields for manually entering the subject's identification information. The driver's license image and the Rx barcode should have information to identify the subject. The identification information of the subject comprises one or more of first name, last name, date of birth, social security number, driver's license number, and domicile.

After acquisition of the subject's identification information, the smart device sends the information to the server to search the selected controlled substance database and the local database for the subject's prescription history, i.e. filled and unfilled prescriptions, step 1212.

In one or more embodiments, the smart device receives the subject's prescription history from said server, step 1214.

In one or more embodiments, the smart device launches a user interface for the user to enter a new prescription intent for the subject, step 1216, and presents the subjects prescription history to the user, 1218. The presentation is preferably through a graphical user interface. The smart device acquires the new prescription intent and sends to the server for saving in the local database, step 1220. Process 1200 ends at step 1222.

While the invention herein disclosed has been described by means of specific embodiments and applications thereof, numerous modifications and variations could be made thereto by those skilled in the art without departing from the scope of the invention set forth in the claims.

What is claimed is:

1. A method for real-time verification of controlled substances comprising:
receiving login credentials of a user for a controlled substance database;
validating said user's credentials with said controlled substance database;
receiving identification information of a subject;
searching said controlled substance database and a local database for said subject using said identification information to obtain the subject's prescription history, wherein said prescription history comprises filled and unfilled prescriptions;
sending said subject's prescription history for display to said user;
receiving said user's prescription intent for said subject; and
securely saving said subject's prescription history and said prescription intent in said local database.

2. The method of claim 1, wherein said login credentials comprises identification of the controlled substance database, said user's Username and Password for said controlled substance database.

3. The method of claim 1, wherein said identification information of said subject comprises one or more of a first name, last name, date of birth, social security number, driver's license number, and domicile.

4. The method of claim 1, wherein said local database is a secured cloud database controlled by said server.

5. The method of claim 1, wherein said controlled substance database is a PDMP database.

6. A method for real-time verification of controlled substances comprising:
obtaining login credentials of a user for a controlled substance database;
sending said login credentials of said user to a server for validation with said controlled substance database;
obtaining identification information of a subject from said user upon said validation;
sending said identification information of said user to said server to search said controlled substance database and a local database for said subject using said identification information to obtain the subject's prescription history;
receiving said subject's prescription history from said server;
requesting a prescription intent for said subject from said user;
displaying said subject's prescription history to said user;
obtaining said prescription intent from said user; and
sending said prescription intent for said subject to said server for saving in said local database.

7. The method of claim 6, wherein said identification information of said subject is obtained from an image of said subject's driver's license.

8. The method of claim 6, wherein said identification information of said subject is obtained by scanning a barcode on said subject's prescription.

9. The method of claim 6, wherein a user identification graphical user interface is launched on said user's device for manually entering said identification information of said subject.

10. The method of claim 6, wherein said login credentials comprises identification of the controlled substance database, said user's Username and Password for said controlled substance database.

11. The method of claim 6, wherein said identification information of said subject comprises one or more of a first name, last name, date of birth, social security number, driver's license number, and domicile.

12. The method of claim 6, wherein said local database is a secured cloud database controlled by said server.

13. The method of claim 6, wherein said controlled substance database is a PDMP database.

14. A computer program product for real-time verification of controlled substances, the computer program product comprising non-transitory computer-readable media encoded with instructions for execution by a processor to perform a method comprising:
obtaining login credentials of a user for a controlled substance database;
sending said login credentials of said user to a server for validation with said controlled substance database;
obtaining identification information of a subject from said user upon said validation;
sending said identification information of said user to said server to search said controlled substance database and a local database for said subject using said identification information to obtain the subject's prescription history;
receiving said subject's prescription history from said server;
requesting a prescription intent for said subject from said user;
displaying said subject's prescription history to said user;
obtaining said prescription intent from said user; and
sending said prescription intent for said subject to said server for saving in said local database.

15. The computer program product of claim 14, wherein said identification information of said subject is obtained from an image of said subject's driver's license.

16. The computer program product of claim 14, wherein said identification information of said subject is obtained by scanning a barcode on said subject's prescription.

17. The computer program product of claim 14, wherein a user identification graphical user interface is launched on said user's device for manually entering said identification information of said subject.

18. The computer program product of claim 14, wherein said login credentials comprises identification of the controlled substance database, said user's Username and Password for said controlled substance database.

19. The computer program product of claim 14, wherein said identification information of said subject comprises one or more of a first name, last name, date of birth, social security number, driver's license number, and domicile.

20. The computer program product of claim 14, wherein said local database is a secured cloud database controlled by said server.
